(19) United States
(12) Patent Application Publication
(10) Pub. No.: US 2007/0071962 A1
(43) Pub. Date: Mar. 29, 2007

(54) Multi-layer ceramic compound

(76) Inventors: Frank Ehlen, Neunkirchen (DE); Olaf Binkle, Kirkel (DE); Ralph Nonninger, Saarbrucken (DE)

Correspondence Address: Walter A. Hackler;Patent Law Office, 2372 S.E. Bristol Street, Suite B, Newport Beach, CA, 92660-0755, US

(21) Appl. No.: 10/545,027

(22) PCT Filed: Nov. 19, 2003
(86) PCT No.: PCT/DE03/03834

§ 371 Date: Aug. 23, 2006

(30) Foreign Application Priority Data
Feb. 13, 2003 (DE) 103 05 864.8

(51) Int. Cl. F26B 11/02; C04B 38/00; B05D 1/36; B32B 5/16; B05D 7/00; B32B 3/00

(52) U.S. Cl. 428/312.2; 501/80; 432/1; 427/202; 427/212; 428/323; 428/701

(57) ABSTRACT

In a method for producing a ceramic compound, a green second layer having ceramic particles of a size of x≦100 nm is disposed onto a green carrier layer. During sintering together of the green layers, the second layer is compacted into a flawless, fine-pored functional layer.

### BACKGROUND OF THE INVENTION

The invention concerns a method for producing a multi-layer porous ceramic compound which consists of at least one first layer of ceramic particles, which is provided as carrier layer for at least one second layer of ceramic particles, wherein the first and second layers are sintered together at a temperature of 800° C.≦T≦1200° C. to form a material compound.

A method for this type is disclosed in DE 198 57 591 A1.

Multi-layer porous ceramic compounds can be used e.g. in filter technology and in electronics for forming strip conductor structures. Ceramic multi-layer filters are used e.g. for separating oil-water emulsions in the chip removing production, to clarify beer, for gas purification, gas separation or separation of liquid-solid mixtures. Ceramic filter materials are usually formed from sintered particles with the gaps therebetween forming the pores. For filtering purposes, the portion of pore volume must be as high as possible and the pore size distribution must be as uniform and close as possible. For this reason, ceramic powders with narrow distributed grain size distribution are preferably used for the production of ceramic filter materials.

Ceramic membranes usually consist of a multi-layer system of porous ceramic having individual layers of different pore widths. The actual filtering layer (functional layer) is usually the thinnest layer of the system having the finest pores. It is disposed on a substrate of the system having a structure with larger pores. The substrate simultaneously adopts the mechanical carrier function of the overall system and often also forms structures for collecting filtered matter. A layer which contains ceramic particles but has not yet been sintered is called a green layer. A body made from this material is correspondingly called green body.

The green body is compacted during sintering, thereby changing the shape and/or size of the pores. In the idealized case, the initial body for sintering can be regarded as dense package of spherical particles which are loosely connected at contact points, i.e. which contact and adhere to each other at so-called “necks”. The spaces between the particles form the pores of the initial body. The original pores are complicated structures of the most different geometries. Sintering is performed in two stages at an increased temperature. In the first stage, the overall porosity substantially remains the same. The centers of the particles remain approximately at the same distance from each other. Nevertheless, the surface energy is increased since the shape of the cavities, i.e. the pores, changes from the complicated structures of the initial state into a simple spherical form, thereby obtaining a minimum surface for a given porosity. The particles contact each other at the “necks” which become thicker in the first sintering stage due to material transport. The pores are thereby rounded to produce a minimum pore surface. This material transport is also called grain boundary diffusion. In the second stage, the pores are gradually closed. The material compacts itself by transporting holes to the inner and outer surfaces (volume diffusion). The overall porosity is reduced through compacting the sinter body. The pores are filled through grain boundary diffusion and volume diffusion. In this step, the centers of the original powder particles move together thereby compacting or shrinking of the sinter body.

The extent of an occurring grain boundary diffusion can be detected by the capillary pressure generated in the pores. The shape of the pores is changed through material transport which is initiated by different radii of curvature. The material is transported, in particular, from the “bellies” of the particles to the “necks” of the particles. On average, the bonding of the atoms is stronger on a surface which is curved to the inside (concave) than on a surface which is curved to the outside (convex). The capillary pressure at the “bellies” of the particles is positive, and that at the “necks” of the particles is negative. This pressure difference is the driving force of the material transport. The capillary pressure which initiates sintering of the ceramic green body depends, in addition to the temperature and particle type, also on the size of the particles used, since the convex curvature radius increases with decreasing particle size. For this reason, the temperature at which sintering of a ceramic green body starts (under the precondition that the packaging density in the green body is the same) drops with decreasing particle size of the initial particles.

If several green layers with different ceramic particles are sintered together, the different material properties in the green layers show different shrinkage behavior, i.e. the layers are compacted to different degrees which produces stresses between the layers with the result that undesired defects and cracks form in the functional layer.

DE 198 57 591 A1 discloses production of a ceramic multi-layer filter with a carrier layer and a functional layer in a sintering process at temperatures between 700° C. and 1200° C. To compensate for the varying shrinkage of the different layers, the cited prior art proposes wetting of the ceramic particles with a material such that the particles are covered during sintering by an additional liquid phase. The functional layers which can be thereby obtained, are however relatively thick and have numerous defective locations, which impairs the filtration properties.

### OBJECT OF THE INVENTION

It is therefore the underlying purpose of the present invention to provide a method for producing a ceramic compound with a flawless functional layer, wherein a carrier layer and the functional layer are sintered together.

### SUMMARY OF THE INVENTION

In accordance with the invention, this object is achieved in that in a method of the above-mentioned type, the ceramic particles of the second layer are exclusively nanoscale particles with a particle size of x≦100 nm.

The inventive method permits generation of a thin, flawless second layer which represents a functional layer, through simultaneous sintering with a carrier layer which represents a substrate. While during normal sintering processes, the green body is compacted via grain boundary diffusion and/or volume diffusion, the compacting process can be influenced through selection of a particle size of x≦100 nm in accordance with the invention in such a manner that floating of grain boundary (grain boundary flow or migration) is initiated, which has not yet been observed in connection with ceramic bodies. The grain boundary flow can prevent stresses between the carrier layer and the functional layer which occur, in particular, if ceramic particles of different material properties or sizes are used in the substrate and in the functional layer. Compacting without producing defects is thereby possible up to a certain functional layer thickness. The inventive method permits production of a faultless functional layer which is formed from ceramic particles of the same or different materials as the substrate and which is not peeled off the substrate during or after sintering. It is possible to achieve excellent filtration results with a functional layer of this type. Compared to the production of ceramic compounds, wherein a green layer is disposed onto a previously sintered body, it is possible to produce thicker, flawless layers at sintering temperatures which are reduced by up to 150° C. using the same materials. The inventive method advantageously requires no sintering inhibitors. Moreover, no larger ceramic particles are added to the nanoscale particles.

The nanoscale particles may have different shapes, e.g. be spherical, plate-shaped or fibrous. The particle size refers in each case to the longest dimension of these particles which would e.g. be the diameter if the particles are spherical.

The ceramic materials used are preferably derived from (mixed) metal oxides and carbides, nitrides, borides, silicides and carbon nitrides of metals and non-metals. Examples thereof are Al₂O₃, partially and completely stabilized ZrO₂, mullite, cordierite, perovskite, spinels, e.g. BaTiO₃, PZT, PLZT and SiC, Si₃N₄, B₄C, BN, MoSi₂, TiB₂, TiN, TiC and Ti (C, N). It is clear that this list is incomplete. It is of course also possible to use mixtures of oxides or non-oxides and mixtures of oxides and non-oxides.

In one embodiment of the method, the ceramic compound is formed from three layers, wherein at least one of the layers contains nanoscale particles. The filtering property of the porous ceramic compound can be precisely influenced by providing several layers having different porosities. Particularly good filtration results can be obtained if one of the layers has no defects.

If the ceramic compound is formed from more than three layers, wherein at least two layers comprise nanoscale particles, a multi-layer porous ceramic compound can be formed having good filtering properties.

If the nanoscale particles have a particle size of x≦50 nm, preferably x≦20 nm, and with particular preference of x≦10 nm, a grain boundary flow can be triggered with a low activation energy. This permits use of low sintering temperatures with sintering stresses of approximately 200 MPa.

In an advantageous method variant, the nanoscale particles are disposed onto the substrate through spraying, immersion, flooding or foil casting. If the nanoscale particles are contained in a suspension, disposal thereof onto the substrate is particularly facilitated by the above-mentioned method steps. This measure permits, in particular, good control and adjustment of the layer thickness of the green layer which is disposed onto the substrate, and thereby of the sintered functional layer.

In an advantageous manner, an intermediate layer, in particular, an organic intermediate layer can be disposed onto the carrier layer before applying the nanoscale particles. An organic binder can balance uneven surfaces of the carrier layer and close pores in the carrier layer to avoid infiltration. In particular, the organic binder may be used to treat the substrate to form a suitable carrier structure. The organic intermediate layer vanishes during sintering, such that the filtering properties of the finished ceramic compound are not influenced by the organic binder.

In a particularly advantageous manner, the carrier layer is structured before sintering. The structures may form cavities and channels for discharging filtered matter, in particular, through lamination with other similar ceramic compounds. In a particularly preferred manner, one end of the structures terminates in the carrier layer. By joining similar ceramic compounds, a channel can be formed which is closed on one side. The carrier layers may support each other. When the structures are formed like grooves, in particular, having a semi-circular cross-section, channels may be formed having a substantially circular cross-section by laminating two ceramic compounds having corresponding grooves.

In a preferred further development, structuring is effected through embossing, punching or milling. Milling of the green carrier layer is particularly advantageous. In contrast to embossing which involves displacement of material, the material is removed during milling. Regions of the green layer are not compacted before sintering such that a homogeneous green layer remains which can be uniformly compacted during sintering. This prevents inhomogeneities which disturb the filtering process.

A filtering means can be produced in a simple manner by joining, in particular laminating, several ceramic compound stacks into a ceramic compound before sintering thereby forming cavities, in particular, channels.

Another subject matter of the invention is a multi-layer porous ceramic compound which comprises a substrate and a flawless functional layer which is exclusively sintered from nanoscale particles. A porous ceramic compound of this type comprises a filtering layer of particularly high quality since it has no defects.

In a preferred embodiment, the ceramic compound comprises three layers, wherein one layer contains the nanoscale particles. The material properties of the layers can be matched to each other such that at least one filtering layer is flawless and a high-quality filter is produced.

In an alternative embodiment, the ceramic compound comprises more than three layers, wherein at least two layers comprise nanoscale particles. With this measure, the filtering effect within the ceramic compound can be gradually increased, wherein at least two layers are provided having particularly fine pores and no defects. Moreover, multi-layer strip conductor structures can be formed, wherein the flawless layers formed from nanoscale particles represent an insulator, which permits to arrange strip conductors at small separations from each other in an electrically insulated manner.

Discharge of the filtered matter is particularly facilitated by providing the carrier layer of the ceramic compound with cavities, in particular, channels.

In a method for producing a ceramic compound, a green second layer having ceramic particles of a size of x≦100 nm is disposed onto a green carrier layer. The second layer is compacted into a flawless fine-pored functional layer during sintering together of the green layers.

Further features and advantages of the invention can be extracted from the claims. The individual features may be realized individually or collectively in arbitrary combination in a variant of the invention.

We claim:

1. Method for producing a multi-layer porous ceramic compound consisting of at least one first layer of ceramic particles which is provided as carrier layer for at least a second layer of ceramic particles having different material properties or sizes than the ceramic particles of the first layer, wherein the first and second layers are sintered together as green layers at a temperature of 800° C.≦T≦1200° C. to form a material compound, characterized in that the ceramic particles of the second layer are exclusively nanoscale particles having a particle size of x≦100 nm.

2. Method according to claim 1, characterized in that the ceramic compound is formed from three layers, wherein at least one of the layers contains nanoscale particles of x≦100 nm.

3. Method according to claim 1, characterized in that the ceramic compound is formed from more than three layers, wherein at least two layers comprise nanoscale particles of x≦100 nm.

4. Method according to claim 1, characterized in that the nanoscale particles have a particle size of x≦50 nm, preferably x≦20 nm, and with particular preference of x≦10 nm.

5. Method according to claim 1, characterized in that the nanoscale particles are disposed onto the substrate (carrier layer) through spraying, immersion, flooding, foil casting or the like.

6. Method according to claim 1, characterized in that an intermediate layer, in particular, an organic intermediate layer, is disposed onto the carrier layer before applying the nanoscale particles.

7. Method according to claim 1, characterized in that the carrier layer is structured before sintering.

8. Method according to claim 1, characterized in that the carrier layer is structured through milling.

9. Method according to claim 1, characterized in that several ceramic compound stacks are joined, in particular laminated, prior to sintering to form a ceramic compound thereby forming cavities, in particular channels.

10. Multi-layer porous ceramic compound produced, in particular, in a method according to any one of the preceding claims, which comprises a substrate and a functional layer which is sintered exclusively from nanoscale particles and is flawless due to grain boundary floating.

11. Ceramic compound according to claim 10, characterized in that the ceramic compound comprises three layers, wherein one layer comprises the nanoscale particles.

12. Ceramic compound according to claim 10, characterized in that the ceramic compound comprises more than three layers, wherein at least two layers comprise nanoscale particles.

13. Ceramic compound according to claim 10, characterized in that the carrier layer of the ceramic compound comprises cavities, in particular, channels.
